(19) United States
(12) Patent Application Publication
(10) Pub. No.: US 2008/0087155 A1
(43) Pub. Date: Apr. 17, 2008

(54) Device for Clamping a Blade of Shears Used in the Transverse Cutting of Strips

(75) Inventors: Jurgen Merz, Kreuztal (DE); Jochen Munker, Kreuztal (DE)

Correspondence Address: ABELMAN, FRAYNE & SCHWAB, 666 THIRD AVENUE, 10TH FLOOR, NEW YORK, NY, 10017, US

(73) Assignee: SMS DEMAG AG, DUESSELDORF GERMANY (DE)

(21) Appl. No.: 11/666,201

(22) PCT Filed: Dec. 2, 2005
(86) PCT No.: PCT/EP05/12876

§ 371 Date: Apr. 23, 2007

(30) Foreign Application Priority Data
Dec. 4, 2004 (DE) 10-2004-058-491.5

(51) Int. Cl. B26D 7/26

(52) U.S. Cl. 83/743

(57) ABSTRACT

The invention relates to a device for clamping a blade (10) of a pair of shears, used in the transversal cutting of strips, in particular a pair of shears for transversally cutting rolled strips and/or cropping shears. Said device comprises a piston (3), a piston rod (4), a compression spring (5), a cover (6), a fixing device (7) and a clamping bar (8), a second piston (16) being positioned at a distance from the first piston (3).

The invention relates to a device for clamping a blade of shears for transverse cutting of strips, in particular, shears for transverse cutting of rolled strips and/or cropping shears and formed of clamping wedge, cover, compression spring, piston rod, and piston.

DE 34 23 275 A1 discloses a device for forming a blade gap in drum shears, a blade drum of which is stationary arranged on a pair of carrier shafts with helical drive gear wheels, and has elongate recesses for receiving blade bars. The blade bar is fixedly clamped with a clamping wedge subjected to the action of a spring package via a tie rod. The tie rod carries, at its end remote from the clamping wedge, a piston displaceable in a cylinder, and which is subjected to action of pressure medium fed via a feeding conduit. When the piston is subjected to the pressure medium, the clamping wedge is displaced against the action of the spring package outside of the clamping position, and the blade bar can slide in the elongate recess.

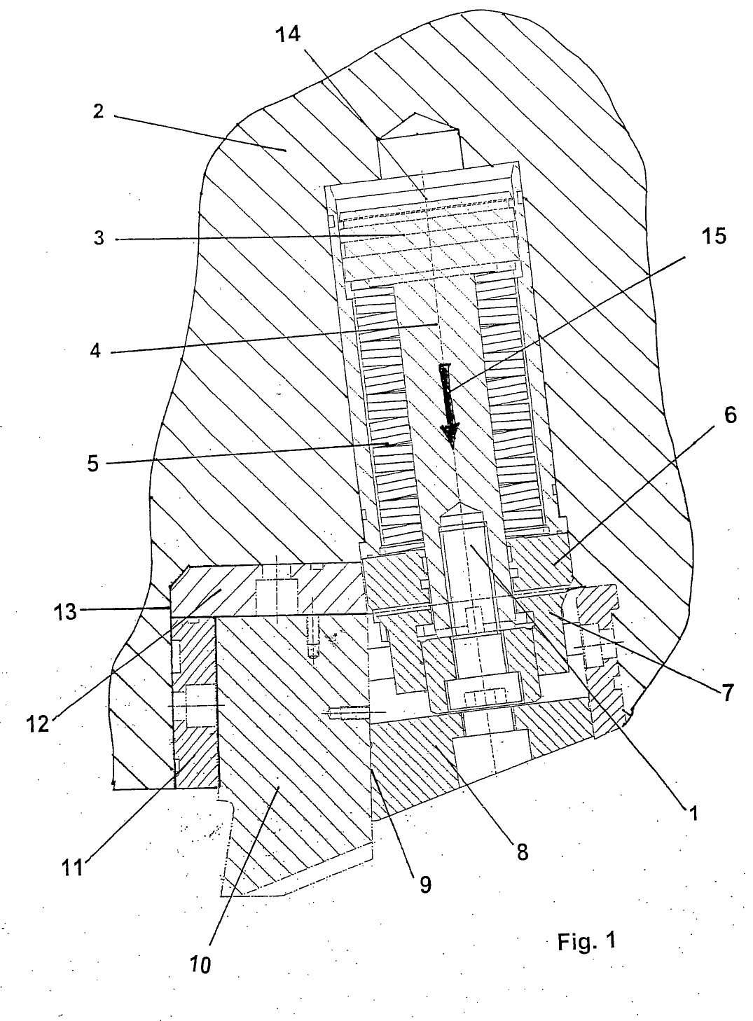

The clamping device of DE 34 23 275 A1 is shown in detail in FIG. 1.

For an exchange of the blade bar, the clamping wedge is also released, as described above. The blade bar can be arranged in a blade drum and in another manner. DE 199 53 908 A1 describes a blade supporting bridge that forms only a section of a blade drum.

The drawback of the available clamping systems consists in that the release pressure which acts on the piston, limits the maximal clamping force with which a blade can be clamped. The clamping force influences the available cutting force of shears. Therefore, the greater the clamping force, the greater is the cutting force of the shears.

Therefore, an object of the invention is to provide a device of the above-described type that would increase the force for releasing the blade.

This object is achieved according to the invention in that in a device according to the preamble of claim 1, a second piston with a second pressure surface is provided.

Advantageous embodiments of the invention are recited in sub-claims.

By increasing the pressure surface by using a second piston, there is provided, in addition to the total pressure surface of the rear piston, an additional or further pressure surface in form of an annular surface. Both surfaces are subjected to action of the pressure medium and apply pressure to the compression spring together. Thereby, the clamping bar releases the blade, making it free. By compressing the compression spring, as described above, the blade is displaced in the elongate opening or is completely taken out for exchange or sharpening. The clamping bar is connected with the piston rod. To this end, a screw connection or a hammer head connection are suitable. A plurality of clamping devices are distributed over the length of the blade drum or the blade supporting bridge.

The pressure medium for releasing the clamping bar is fed to separate clamping devices from a central supply source. Therefore, all of the clamping devices for a blade can be released simultaneously by application of head pressure.

The decisive advantage of the inventive device consists in that the maximal cutting force of the shears is not limited anymore by the blade clamping force. Therefore, thicker and/or wider strips or strips having a higher hardness can be cut at the same size of the shears.

Further, because of the inner geometry, the load on the adjacent components changes. E.g., the cover of the clamping cylinder is loaded by half of the load.

An embodiment of the invention would be described in detail based on very schematic drawings. The drawings show:

FIG. 1 a known clamping device (state of the art), and

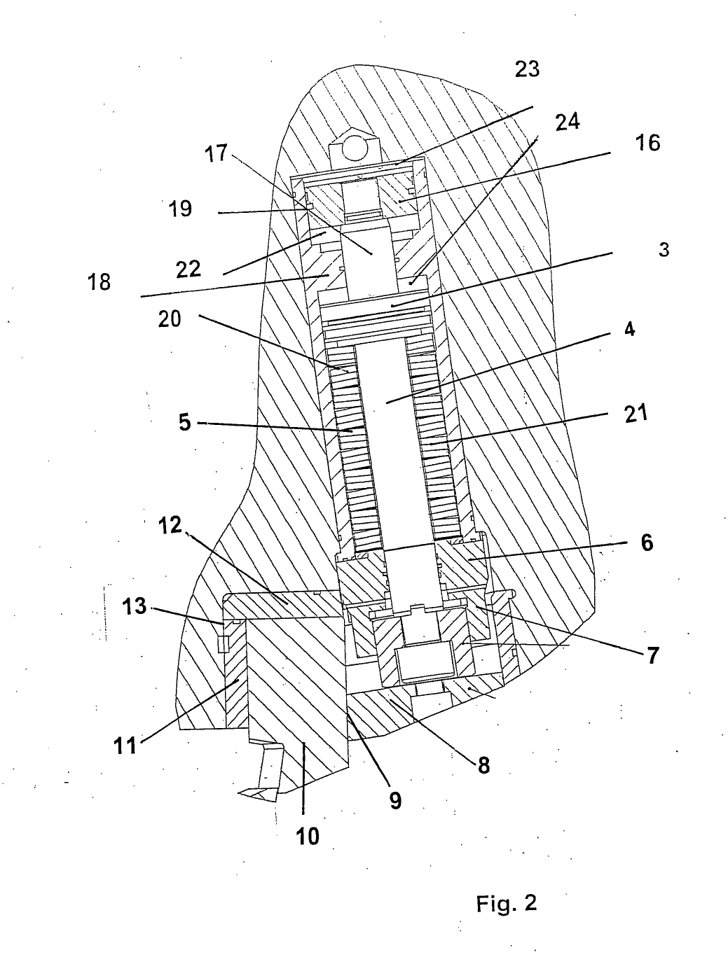

FIG. 2 a clamping device according to the invention.

In the FIG. 1 a clamping device 1 in a blade drum 2 is shown. The clamping device 1 is formed of a piston 3, a piston rod 4, a compression spring 5, a cover 6, and an attachment device 7 for a clamping bar 8.

The clamping bar 8 presses with an inclined surface 9 a blade 10 against stop bars 11 and 12 which limit an elongate recess 13 for receiving the blade 10. For insertion or release of the blade 10, a pressure medium is applied to a rear surface 14 of the piston 3. Thereby, the piston 3 is displaced, together with the piston rod 4, in a direction of arrow 15, whereby simultaneously, the compression spring 5, in the present case a package of conical disc springs, becomes compressed. The clamping bar 8, which is likewise displaced in the direction of arrow 15, releases the blade 10. The blade 10 can now be taken out or displaced.

The device, which is known from FIG. 1, is changed according to FIG. 2 in that there is provided an additional piston 16 which is arranged at a distance from the known piston 3.

The piston 16 has a piston rod section 17 displaceable in a cylinder section 18. The pistons 3, 16 and the piston rod section 17 all have seals 19. The chamber 20 for receiving the conical disc spring package 21 and the chamber 23 in front of the rear piston 16 are under environmental pressure, whereas the chamber 23 behind the rear piston 16 and the annular chamber 24 behind the front piston 3 are subjected to application of pressure medium (not shown). Both chambers 23 and 24 are connected with each other by connection bores (not shown).

### LIST OF REFERENCE NUMERALS

1. Clamping device
2. Blade drum
3. Piston
4. Piston rod
5. Compression spring
6. Cover
7. Attachment device
8. Clamping bar
9. Inclined surface
10. Blade
11. Stop bar
12. Stop bar
13. Elongate recess
14. Rear piston surface
15. Arrow
16. Piston
17. Piston rod segment
18. Cylinder section
19. Seal
20. Chamber
21. Conical disc spring package
22. Annular chamber
23. Chamber
24. Chamber

1. A device for clamping a blade (10) of shears for transverse cutting of strips, in particular, shears for transverse cutting rolled strips and/or cropping shears, comprising a piston (3), a piston rod (4), a compression spring (5), a cover (6), an attachment device (7), and a clamping bar (8),
characterized in that
a second piston (16) is arranged at a distance from the first piston (3), wherein a piston rod section (17) is formed between the first piston (3) and the second piston (16).

2. (canceled)

3. A device according to claim 1,
characterized in that
the piston rod (4) and the piston rod section (17) have the same diameter.

4. A device according to claim 1,
characterized in that
diameters of the piston rod (4) and the piston rod section (17) are different.

5. A device according to claim 1,
characterized in that
the first piston (3) and the second piston (16) have the same diameter.

6. A device according to claim 1,
characterized in that
the diameter of the first piston (3) and of the second piston (16) are different.

7. A device according to claim 1,
characterized in that
the pistons (3, 16) have seals (19).

8. A device according to claim 1,
characterized in that
the compression spring (5) is a spiral spring.

9. A device according to claim 1,
characterized in that
the compression spring (5) is a conical disc spring package.
